(19) United States
(12) Patent Application Publication
(10) Pub. No.: US 2024/0323016 A1
(43) Pub. Date: Sep. 26, 2024

(54) Verify Public Keys by Devices without Secrets for the Generation of Respective Private Keys

(71) Applicant: Micron Technology, Inc., Boise, ID (US)

(72) Inventor: Paul Aerick Lambert, Mountain View, CA (US)

(21) Appl. No.: 18/425,927

(22) Filed: Jan. 29, 2024

Related U.S. Application Data
(60) Provisional application No. 63/491,336, filed on Mar. 21, 2023.

(51) Int. Cl. H04L 9/30; H04L 9/08; H04L 9/14

(52) U.S. Cl. CPC H04L 9/3073; H04L 9/0819; H04L 9/0841; H04L 9/0861; H04L 9/14

(57) ABSTRACT

Systems, apparatuses, and methods to verify or validate a public key. For example, a computing device computes an intermediate key from inputs known to both the computing device and a remote device, and combines the intermediate key and a first private key via an operation (e.g., summation or multiplication) to generate a second private key. A second public key computed for the second private key by the computing device can be transmitted to the remote device for verification or validation without the remote device having data to identify the private keys. For example, the remote device can separately compute the intermediate key from the inputs and then combine the intermediate key with a first public key of the first private key (e.g., via summation or multiplication) to generate a version of the second public key for comparison with the second public key received from the computing device.

### RELATED APPLICATIONS

The present application claims priority to Prov. U.S. Pat. App. Ser. No. 63/491,336 filed Mar. 21, 2023, the entire disclosures of which application are hereby incorporated herein by reference.

### TECHNICAL FIELD

At least some embodiments disclosed herein relate to computer security in general and more particularly, but not limited to, generation and verification of the identities of computing devices.

### BACKGROUND

A computing device, such as an internet of things (IoT) device, can be configured to have an unique identity, among a population of similar devices, based on cryptography and a unique secret stored in the computing device. For example, the identity can be established based on a combination of hardware and software/firmware of the computing device according to operations and requirements specified for device identifier composition engine (DICE). The unique identity of the computing device and its validation provide a basis of trust for the use, deployment and service of the computing device.

For example, a memory sub-system can be configured to secure a unique secret that is the basis of the unique identity of a computing device.

In general, a memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 shows the generation of an asymmetric cryptographic key pair based on an existing key pair according to one embodiment.

FIG. 2 shows the generation of a key pair representative of the identity of a computing device in combination with an add-on component based on a key pair representative of the identity of the computing device according to one embodiment.

FIG. 3 shows another technique to generate a key pair representative of the identity of a computing device in combination with an add-on component according to one embodiment.

FIG. 4 shows the generation of an identity of a computing device having an updatable component according to one embodiment.

FIG. 5 shows the verification of a public key of a device by a remote server according to one embodiment.

FIG. 6 shows the generation of a secondary key pair based on a shared secret and a primary key pair according to one embodiment.

FIG. 7 illustrates an integrated circuit memory device according to one embodiment.

FIG. 8 illustrates the generation of identity data in an integrated circuit memory device according to one embodiment.

FIG. 9 illustrates a technique to control execution of a command in a memory device according to one embodiment.

FIG. 10 shows a method to manage cryptographic keys according to one embodiment.

FIG. 11 illustrates an example computing system having a memory sub-system in accordance with some embodiments of the present disclosure.

FIG. 12 is a block diagram of an example computer system in which embodiments of the present disclosure can operate.

### DETAILED DESCRIPTION

At least some aspects of the present disclosure are directed to the techniques of generating an asymmetric cryptographic key pair in a device in a way that enables an external system to verify the correctness of the public key in the key pair without the need to provide the external system with access to the private key in the key pair and/or the secrets used in the generation of the private key.

For example, in some techniques of asymmetric cryptography (e.g., elliptic curve cryptography), a public key of a private key can be generated via multiplying the private key by a generator element of a group used for public key operations. A new private key in a new key pair can be generated from an operation that is applied to an existing private key and an intermediate key. When the order of applying the operation and the multiplication by the generator element can be changed in the generation of the public key without changing the result, the new public key in the new key pair can be computed from the public key of the existing public key and the intermediate key,

For example, the operation can be a summation operation such that the new private key is computed from the sum of the existing private key and the intermediate key. As a result, the new public key can be computed from the sum of the existing public key and a public key computed for the intermediate key.

For example, the operation can be a multiplication operation such that the new private key is computed from the multiplication of the existing private key with the intermediate key. As a result, the new public key can be computed from the multiplication of the existing public key with the intermediate key.

When such techniques of generating a new key pair is used, an external system having access to the existing public key and the intermediate key can independently compute the new public key to verify the correctness of the new public key for the new private key, without the need to access to data that can compromise the secrecy of the new private key and/or the existing private key.

For example, the techniques can be used in the generation of an alias key pair in a computing device to represent a computing device having a unique device secret and running a software/firmware component. When the component is updated in the computing device (e.g., via an over the air update), a new alias key pair can be computed in the computing device to represent the computing device having the unique device secret and running the updated software/firmware component. The alias key pair can be used as a new unique secret (and a new identity) of the software/firmware running in the computing device. The updated software/firmware component can be hosted in a server computer for retrieval and for over the air updates. Thus, the server computer can have information about the correct version of the software/firmware component. The server computer can be configured to verify that the public key (and thus the private key) in the new alias key pair of the version of software/firmware running in the computing device is correct via computing the public key independently from the computing device. The correctness of the public key computed by the computing device can be seen as the correctness of installation/update of the software/firmware in the computing device. The server computer can be configured to verify the correctness of the public key in the new alias key pair without access to the secrets of the computing device, such as the private key in the new alias key pair, the unique device secret of the computing device.

For example, the technique can be used to establish a new identity of a device, based on an existing identity of the device, for communication with another device in a particular context.

For example, through a peer-to-peer Diffie-Hellman (DH) key exchange, two devices A and B can establish a shared secret for a context (e.g., a session). An intermediate key can be generated from the shared secret and other inputs representative of the context for the generation of a new identity of a device (e.g., A) (or new identities of both devices A and B). For example, a new private key in a device A can be generated from an existing private key of the device A and the intermediate key (e.g., via summation or multiplication); and the new public key of the device A can be computed, independently by both devices A and B, from the existing public key of the device A shared between the devices A and B. The trust in the existing public key of device A shared between the devices A and B can be carried as the trust in the new public key shared between the devices A and B, since both devices A and B can verify the correctness of the new public key, while new private key remains a secret in device A, even though the secrecy of the intermediate key may not be preserved. Similarly, device B can establish a new private key based on the intermediate key and an existing private key of the device B; and a new public key of the new private key that can be validated by device A using the existing public key of device B and the intermediate key. The use of the new key pairs can reduce the usages of the existing key pairs and thus improve the secrecy of the existing key pairs.

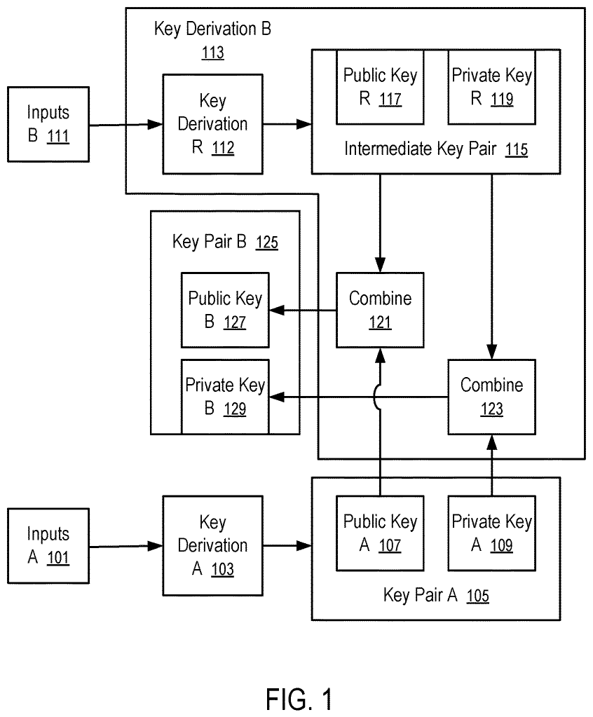

FIG. 1 shows the generation of an asymmetric cryptographic key pair 125 based on an existing key pair 105 according to one embodiment.

In FIG. 1, inputs 101 is provided to a function of key derivation 103 to generate a key pair 105 of asymmetric cryptography, including a public key 107 and a private key 109.

In general, a function of key derivation (e.g., 103, 113, 112) includes a cryptographic operation such that while it is easy to compute a key pair (e.g., 105) from inputs (e.g., 101), it is impractical to determine the inputs (e.g., 101) from the resulting key pair (e.g., 105).

In general, an encrypted message generated via asymmetric cryptography (e.g., elliptic curve cryptography) using a private key (e.g., 109) in a key pair (e.g., 105) can be decrypted using a public key (e.g., 107) in the key pair (e.g., 105). An encrypted message generated via asymmetric cryptography using the public key (e.g., 107) can be decrypted using the private key (e.g., 109). Each of the keys (e.g., 107 and 109) can have a number of bits when represented in a binary format. When the number of bits in the keys (e.g., 107 and 109) is sufficiently large (e.g., when long keys are used), the security of the key system is strong in preventing a successful attack using a conventional computer system. For example, it is impractical to determine the private key (e.g., 109) from the public key (e.g., 107); it is impractical to decrypt a message encrypted using the public key (e.g., 107) without the private key (e.g., 109); and it is impractical to generate, without the private key (e.g., 109), an encrypted message that can be correctly decrypted using the public key (e.g., 107).

For example, after generating the private key 109 from the inputs 101, the public key 107 can be generated from the private key 109, e.g., by multiplying the private key 109 by a generator element of a group used for public key operations. The result of the multiplication can be truncated to retain a predetermined number of least significant bits as the public key 107. Thus, while it is easy to generate the public key 107 from the private key 109, it is difficult or impractical to determine the private key 109 from the public key 107. Thus, the public key 107 can be provided to the public without compromising the secrecy of the private key 109.

In general, the function of key derivation 103 can be a set of operations known to the public. The inputs 101 can include a secret, such as a unique device secret configured in a memory device, to ensure the secrecy of the private key 109. Thus, the private key 109 is representative of a combination of the inputs 101, including the secret included in the inputs 101. A device having the private key 109 can be seen as having the secret (e.g., unique device secret configured in a memory device).

In some applications, it is useful to generate a new key pair 125 to represent the combination of inputs 101 and further inputs 111. While it is possible to combine inputs 111 and 101 to generate a key pair using the function of key derivation 103, it is difficult for an external system without access to the inputs 101 to verify the correctness of combining the inputs 111 and 101 in the generation of a key pair from the key derivation 103.

In FIG. 1, key derivation 113 is configured to generate a new key pair 125 from the existing key pair 105 and the inputs 111. The inputs 111 are provided to a function of key derivation 112 to generate an intermediate key pair 115 having a public key 117 and a private key 119.

For example, after the intermediate private key 119 is generated by key derivation 112 from the further inputs 111, the public key 117 can be computed from the multiplication of the private key 119 by the same generator element used to generate the public key 107 from the private key 109.

In general, the key derivations 112 and 103 can use a same function, or different functions. The key derivation 112 and key derivation 103 can have apply the same operation to generate the public keys 107 and 117 from the respective private keys 109 and 119 (e.g., via multiplication by the same generator element).

Subsequently, the key derivation 113 further includes an operation to combine 123 the private keys 109 and 119 to generate a new private key 129 in the new key pair 125. As a result, the new public key 127 can be generated by an operation to combine 121 the intermediate public key 117 (or the intermediate private key 119) and the existing public key 107. The result of combining 121 with the public key 107 can be the same as the result of computing the public key 127 from the private key 129 (e.g., via multiplication by the same generator element).

Since the public key 127 can be computed independently by an external system that has the further inputs 111 and the public key 107, the external system can verify the correctness of the public key 127 computed from the inputs 101 and 111. The correctness of the new public key 127 can be used as a proxy of the correctness of combining inputs 101 and 101 in a computing device. Further, the ability to validate the new public key 127 can be used in preventing man-in-the-middle attacks in the use of the new key pair 125.

The data (e.g., inputs 111 and the existing public key 107) used by the external system in the verification/validation of the new public key 127 does not include or reveal any of the private keys 129 and 109, and the secret in the inputs 101. From the data used by the external system to verify the correctness of the new public key 127, it is difficult or impractical to determine the private key 129, the private key 109, or the secret in the inputs 101. Thus, the secrecy of the private key 129, the private key 109, and the secret in the inputs 101 is maintained, while the external system is still provided with the opportunity to validate the new public key 127.

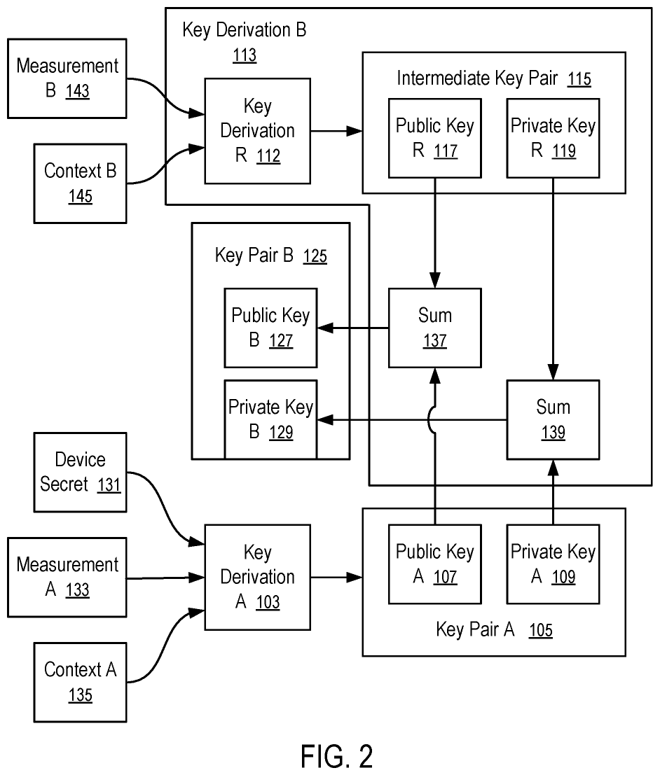

For example, when the new private key 129 is generated from combining 123 private keys 109 and 119 via summation, the public key 127 can be computed from combining 121 public keys 107 and 117 via summation (e.g., as in FIG. 2).

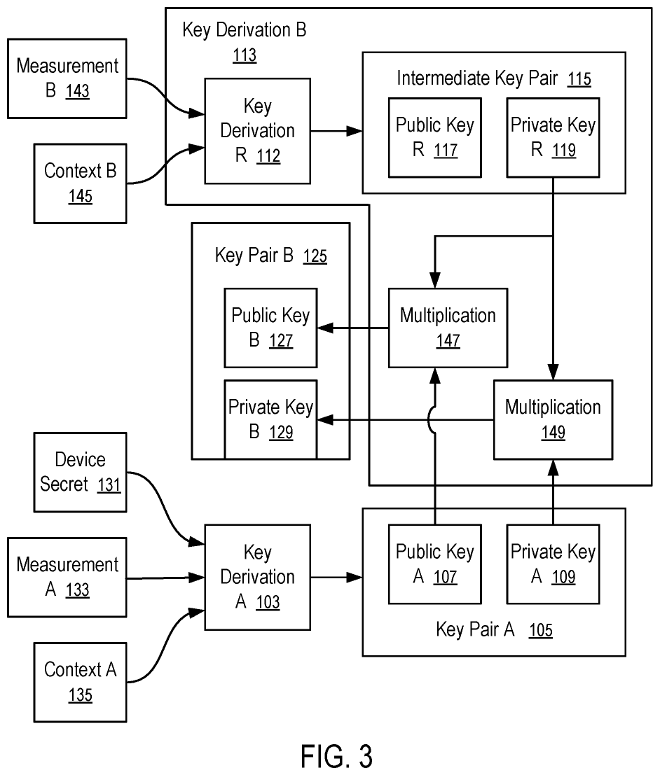

For example, when the new private key 129 is generated from combining 123 private keys 109 and 119 via multiplication, the public key 127 can be computed from combining 121 the public key 107 and the private key 119 via multiplication (e.g., as in FIG. 3).

FIG. 2 shows the generation of a key pair representative of the identity of a computing device in combination with an add-on component based on a key pair representative of the identity of the computing device according to one embodiment. For example, the technique of FIG. 2 can be used as an example of the technique of FIG. 1.

In FIG. 2, a device secret 131 of a computing device, a cryptographic measurement 133 of a set of one or more layers of software/firmware components configured to run in the computing device, and a context 135 of operating the computing device can be provide as input to the key derivation 103 to generate a key pair 105 as the identity and device secret of the computing device running the one or more layers of software/firmware components in the context 135.

In general, a cryptographic measurement (e.g., 133, 143) of a component can be a value resulting from applying a cryptographic hash function to the data of the component. It is difficult and impractical to modify the data of the component without changing its cryptographic measurement. Thus, the correctness of a cryptographic measurement can be seen as a reliable representation of the integrity of the data of the component.

When a further layer of software/firmware component represented by a measurement 143 is configured to run in the computing device in a context 145 with the one or more layers of software/firmware represented by the measurement 133, the key derivation 113 can be used to generate a new key pair 125 as the identity and device secret of the computing device running the combination of software/firmware components represented by the measurements 143 and 133.

When there are multiple layers of software/firmware components represented by the measurement 133, the key derivation 103 can be constructed in a chain, in a similar to the generation of the new key pair 125.

For example, the measurement 143 can represent an upper layer of software/firmware component that runs on top of a lower layer of software/firmware component represented by the measurement 133. The key pair 105 generated from the key derivation 103 can be used as the device secret of the lower layer. The device secret of the lower layer (e.g., key pair 105) can be provided as to the key derivation 113 to generate the new key pair 125 as the device secret of the upper layer. The device secret 131 used to generate the key pair 105 of the lower layer can be in turn a cryptographic key pair generated from the measurement of a further lower layer, or the hardware (e.g., a unique device secret secured in a read-only memory of the computing device).

In FIG. 2, the new private key 129 is generated from a sum 139 of the intermediate private key 119 and the existing private key 109. Thus, the same public key 127 in the new key pair 125 can be computed from the new private key 129 directly (e.g., via multiplication by the same generator element used to generate the public key 107 from the private key 109), or from the sum 137 of the intermediate public key 117 and the existing public key 107. As a result, another device having access to the public keys 117 and 107 can validate/verify the new public key 127 computed by the computing device. The secrets of the computing device (e.g., private keys 129 and 109, and device secret 131) can be protected from being accessed by the device tasked to verify/validate the correctness of the public key 127 provided by the computing device running the component represented by the measurement 143 in combination with other components represented by the existing key pair 105.

FIG. 3 shows another technique to generate a key pair representative of the identity of a computing device in combination with an add-on component according to one embodiment. For example, the technique of FIG. 3 can be used as an example of the technique of FIG. 1.

Similar to the technique in FIG. 2, the technique of FIG. 3 can be used to generate a new key pair 125 to represent a combination of an upper layer component represented by a further measurement 143 and one or more lower layer components represented by an existing key pair 105.

In FIG. 3, the new private key 129 is generated from a multiplication 149 of the intermediate private key 109 by the existing private key 119. Thus, the same public key 127 in the new key pair 125 can be computed from the new private key 129 directly (e.g., via multiplication by the same generator element used to generate the public key 107 from the private key 109), or from the multiplication 147 of the intermediate private key 119 by the existing public key 107. As a result, another device having access to the intermediate private key 119 and the public key 107 can validate/verify the new public key 127 computed by the computing device. The secrets of the computing device (e.g., private keys 129 and 109, and device secret 131) can be protected from being accessed by the device tasked to verify/validate the correctness of the public key 127 provided by the computing device running the component represented by the measurement 143 in combination with other components represented by the existing key pair 105.

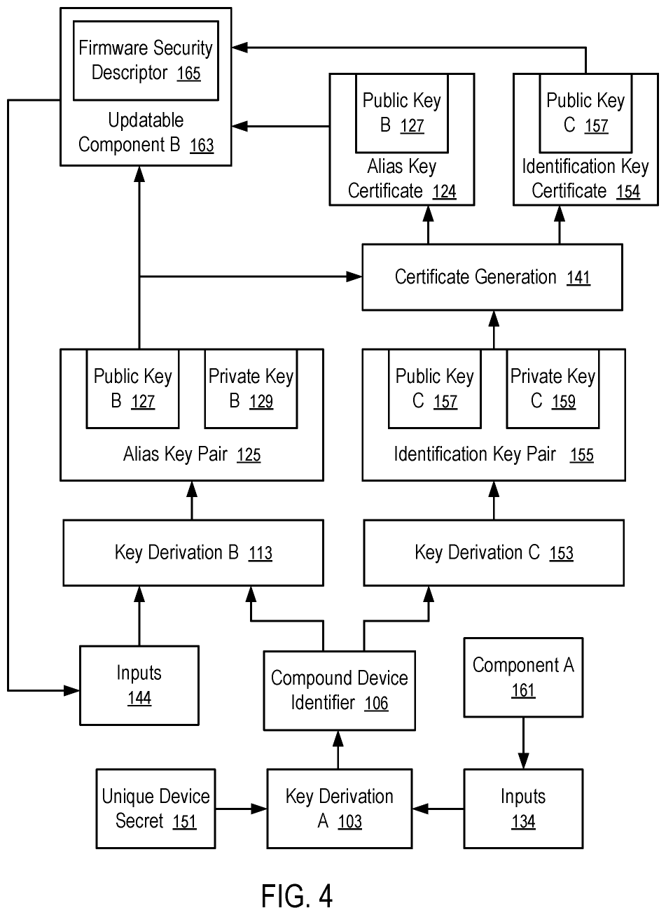

FIG. 4 shows the generation of an identity of a computing device having an updatable component according to one embodiment. For example, the identity generation of FIG. 4 can be implemented using the techniques of FIG. 1, FIG. 2, or FIG. 3.

For example, a computing device having a unique device secret 151 secured in a read-only memory can use the identity generation of FIG. 4 to update one of its identities when a component 163 is updated.

The unique device secret 151 of the computing device can be the root identity of the computing device. To generate an identity of the computing device having a component 161, inputs 134 can be generated to include a cryptographic measurement of the component 161 and a context of the component 161 being used in the computing device.

Key derivation 103 can generate a key pair (e.g., 105 in FIG. 1 to FIG. 3) as a compound device identifier 106 of the computing device operating with the component 161.

The compound device identifier 106 (e.g., as a key pair 105 in FIG. 1 to FIG. 3) can be provided as a device secret to the key derivation 113 to generate a new key pair as the alias key pair 125. The inputs 144 to the key derivation 113 can include a measurement of the updatable component 163 and a context (e.g., 145) of the use of the component 163 in the computing device having the component 161. For example, the inputs can include a firmware security descriptor (FSD) 165 of the updatable component 163.

For improved security, a separate identification key pair 155 can be generated via key derivation 153 to represent the component 163 used in the computing device on top of the component 161. The identification key pair 155 includes an identification public key 157 and an identification private key 159. In general, the key derivation 153 for the identification key pair 155 can be same as, similar to, or different from the key derivation 113 for the alias key pair 125.

The computing device can use a certificate generation 141 to generate an alias key certificate 124 to provide the alias public key 127 and the identification key certificate 154 to provide the identification public key 157. The certificates 124 and 154 can be signed using the identification private key 159.

The updatable component 163 running in the computing device on top of the component 161 can use the alias key pair 125 as its compound device identifier and its device secret.

Optionally, another upper-layer updatable component can be configured to run on top of the component 163; and the alias key pair of the upper-layer updatable component can be generated in a way similar to the generate of the alias key pair 125 of the component 163 configured on top of the component 161.

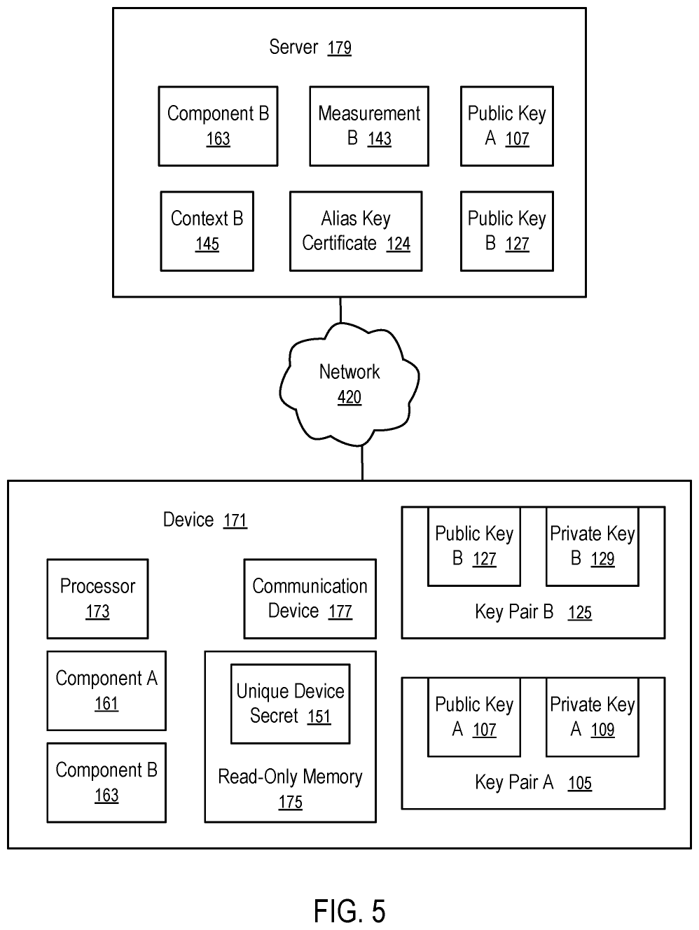

A server system in control of distributing the updatable component 163 can be configured to validate the alias public key 127 provided in the alias key certificate 124. The server system can have access to the inputs 144 and/or the intermediate key pairs 115 for the generation of the alias key pair 125 in the key derivation 113. However, the server system is not provided with the private key (e.g., 109) in the compound device identifier 106. Thus, the server system does not have access to the alias private key 129 and/or other secrets of the computing device (e.g., unique device secret 151). Using the techniques of FIG. 1, FIG. 2, or FIG. 3, the server system can still verify and validate the alias public key 127 provided in the alias key certificate 124. Through the verification and validation of the alias public key 127 provided in the alias key certificate 124, the server system can confirm the correct installation of the updatable component 163 in the computing device and the validity of the certificates 124 and 154, as in FIG. 5

FIG. 5 shows the verification of a public key of a device by a remote server according to one embodiment. For example, the alias public key 127 provided in the alias key certificate 124 in FIG. 4 can be validated via a server 179 in FIG. 5.

In FIG. 5, a computing device 171 has a processor 173, a communication device 177, and a read-only memory 175 securing a unique device secret 151. The processor 173 can operate based on components 161 and 163, such as a bootloader, an operating system/firmware, an application etc.

The device 171 can establish a key pair 105 as a compound device identifier 106 representing the computing device 171 running the component 161. Through secure operations, the device 171 can provide the public key 107 in the compound device identifier 106 to the server 179 such that the server 179 can trust the public key 107. For example, the correctness of the public key 107 can be validated and verified by another server that controls the distribution of the component 161 and/or the device 171.

When the component 163 is installed (e.g., through an over the air update, or an initial installation in the device 171, or during the manufacture of the device 171), the device 171 can compute a new key pair 125 (e.g., as the alias key pair 125) representing the computing device 171 running the component 163 on top of the component 161, as in FIG. 4.

The computing of the alias key pair 125 can be based at least in part on a cryptographic measurement 143 of a valid version of the component 163 secured in the server 179, and a context 145 of the installation and/or operation of a copy of the component 163 in the device 171. Optionally, the context 145 can include private information shared between the server 179 and the device 171, such as a secret established via Diffie-Hellman (DH) key exchange. Optionally, the context 145 can include information unique to the device 171 and/or the use of the component 163 in the device 171.

The component 161 running in the device 171 can communicate, using the communication device 177, the alias key certificate 124 to the server 179 for validation, verification, and/or distribution. The alias key certificate 124 can include a copy of the alias public key 127 computed by the device 171. Using the techniques of FIG. 1, FIG. 2, or FIG. 3, the server 179 can independently compute the public key 127 from the public key 107, the cryptographic measurement 143, and the context 145 known to the server 179.

If the server 179 determines that its computed public key 127 agrees with the public key 127 provided in the alias key certificate 124, the server 179 can conclude that the device 171 has a correct copy of the component 163 installed, and that the alias key certificate 124 is valid. Otherwise, the server 179 can reject the alias key certificate 124 and/or the installation of the component 163 in the device 171.

For example, when the server 179 determines that the alias public key 127 computed by the device 171 is incorrect, the server 179 can request the device 171 to re-install a fresh copy of the component 163 to ensure that the component 163 in the device 171 is not corrupted or tampered with. Optionally, the server 179 is configured to provide a service in connection with the component 163; and services requests from the device 171 can be rejected when the public key 127 computed by the device 171 is incorrect. Optionally, the server 179 can function as a certificate authority for key certificates of copies of the component 163 running in a population of devices (e.g., 171) connected to the network 420, including alias key certificates (e.g., 124) and device identification key certificates (e.g., 154).

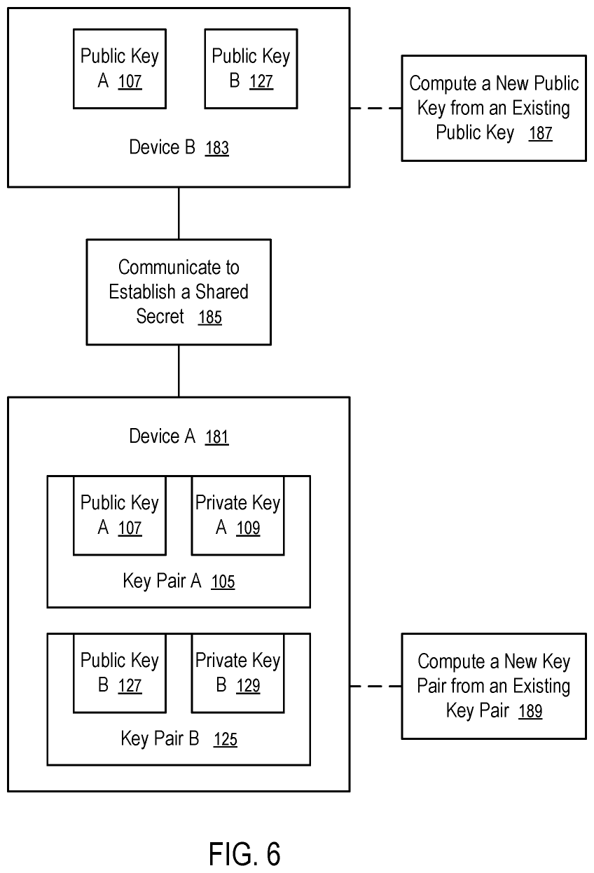

FIG. 6 shows the generation of a secondary key pair based on a shared secret and a primary key pair according to one embodiment. The generation and validation of an alias key pair 125 in FIG. 4 and FIG. 5 from a compound device identifier 106 can be seen as an example of FIG. 6.

In FIG. 6, a device A 181 having a primary key pair 105. A device B 183 has a correct version of the public key 107 in the primary key pair 105. The device A 181 can use the techniques of FIG. 1, FIG. 2, and FIG. 3 to generate a secondary key pair to represent the device 181 in a new context in a way that allows the device B 183 to trust the secondary key pair 125, as represented by the public key 127 (or a certificate of the public key 127), in a same level as its trust in the primary key pair 105, as represented by the public key 107 (or a certificate of the public key 107).

For example, to generate the secondary key pair 125, the devices 181 and 181 can communicate 185 to establish a shared secret. For example, the shared secret can be established via Diffie-Hellman (DH) key exchange over an open network (e.g., 420) such that the secret is known to both devices 181 and 183, while other devices on the network (e.g., 420) are prevented from obtaining the secret. The secret can be used as part of the context 145 in key derivation 112 to generate an intermediate private key 119 that is known only to the devices 181 and 183. Using the secret can improve the security of the private key 109 in the secondary key pair 125. However, it is not necessary to use the secret as part of the context 145 in the generation of the secondary key pair 125. When the secondary key pair 125 does not involve the use of a component of data, software, or firmware, the use of a cryptographic measurement 143 in the key derivation 112 (e.g., as in FIG. 2 or FIG. 3) can be skipped. Optionally, additional information that can be known to other devices on the network (e.g., 420) can also be used as part of the context 145.

Using the techniques of FIG. 1, FIG. 2, or FIG. 3, the device 181 can compute 189 the new key pair 125 from the existing key pair 105. Separately, the device 183 can compute 187 the new public key 127 from the public key 107 in existing key pair 125. As a result, the device 183 can validate and verify the correctness of the secondary key pair 125 computed in the device 181. After the validation/verification, the device 181 can use the secondary key pair 125 as an identity (e.g., to reduce the use of the primary key pair 105, to demonstrate the context 145 represented at least in part by the shared secret, to replace the primary key pair 105, etc.).

Optionally, the device 183 can similarly use the shared secret to generate its secondary key pair that can be validated, verified, and trusted by the device 181 to a same degree as to the trust of the primary key pair of the device 183.

In general, software/firmware of the computing device can include multiple layers of components of trusted computing base (TCB), such as a bootloader, an operating system, and an application. During a boot process, the components can be loaded into the computing device for execution in a sequence that corresponds to the order of layers. The computing device having loaded up to a component at a particular layer (e.g., bootloader, operating system, or application) can have a compound device identifier (CDI) representative of the computing device running the components having been loaded, and a corresponding cryptographic key usable to demonstrate that the computing device has the compound device identifier (CDI). The compound device identifier (CDI) can be an identifier of the last component of the particular layer having been loaded into the computing device.

Each component can have a TCB component identity (TCI) that characterizes the component. For example, a TCB component identity (TCI) of a software/firmware component can be based on a cryptographic measurement of the component and other information, such as an identification of the manufacturer/vendor of the component, a version number, a build number, a serial number, a component name, etc. For example, the cryptographic measurement can be a value calculated by applying a cryptographic hash function to the data of the component (e.g., the instructions and resources of the component). Such a measurement or value can be referred to as a digest or measurement of the component.

Layers of components can be linked or chained for enhanced security for the trust base. For example, the compound device identifier (CDI) of a current layer component (e.g., layer i) can be generated, by a previous layer component (e.g., layer i−1) based on a secret of the previous layer component, and the TCB component identity (TCI) of the current component; and the compound device identifier (CDI) of the current layer component (e.g., layer i) can be used as the unique secret for the next layer component (e.g., layer i+1).

When a component is compromised (e.g., corrupted, tampered with), its compound device identifier (CDI) and thus cryptographic key will be different from when the component is not compromised and thus cannot pass validation. When the techniques of FIG. 1, FIG. 2, or FIG. 3 are used, an external device can perform the validation based on checking the correctness of an alias public key (e.g., 127).

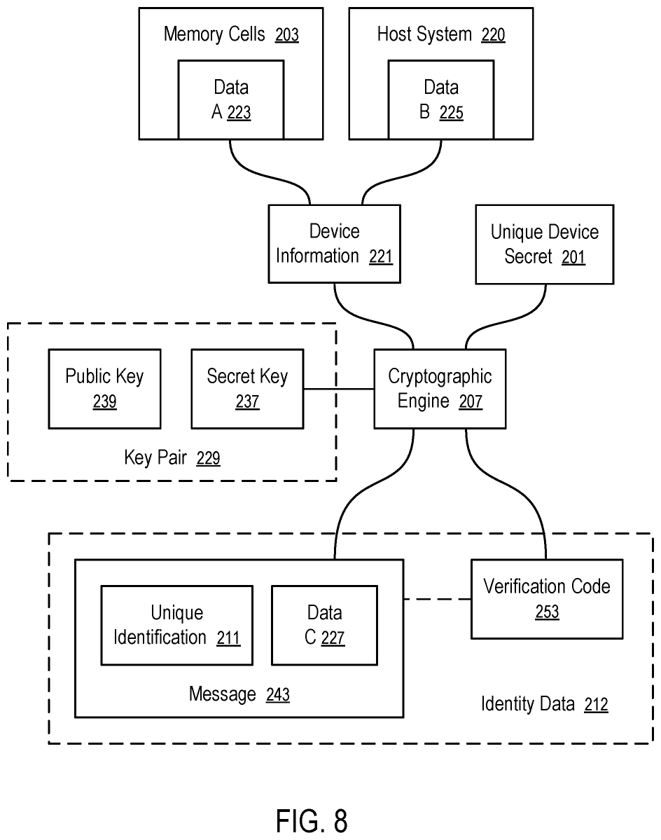

A secure memory device can store an unique device secret representative of the memory device. A cryptographic key can be generated based at least in part on the unique device secret. A digital signature generated using the cryptographic key can be used to demonstrate the identity of the memory device represented at least in part by the unique device secret, as further discussed below in connection with FIG. 8.

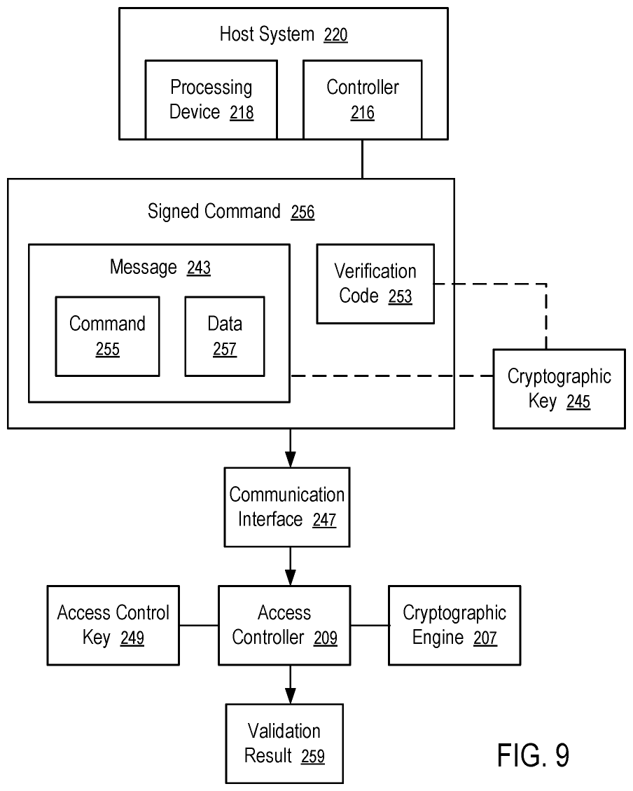

The secure memory device can require a command to be signed using a cryptographic key before the command is executed to access a secure memory region. The cryptographic key is representative of the privilege to access the secure memory region. Thus, without the cryptographic key, an application or entity cannot access the secure memory region, as further discussed below in connection with FIG. 9.

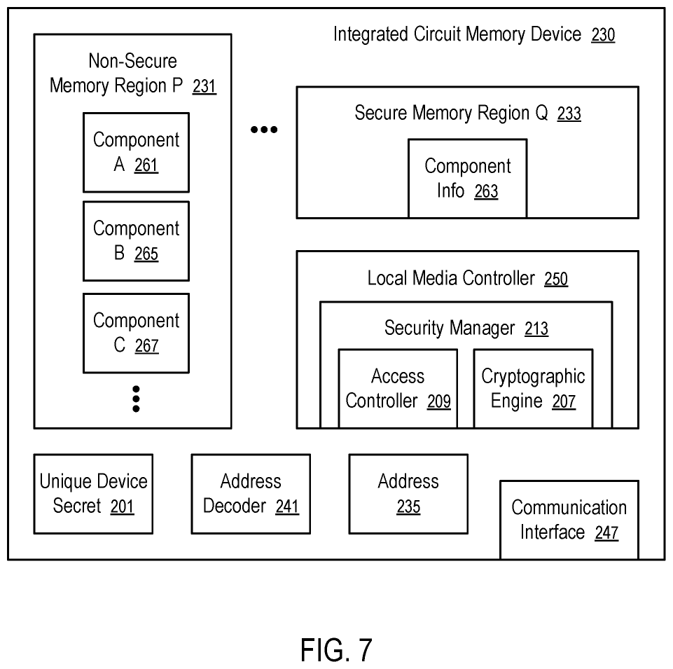

FIG. 7 illustrates an integrated circuit memory device 230 according to one embodiment. For example, the key generation techniques of FIG. 1 to FIG. 6 can be implemented in a security manager 213 in the integrated circuit memory device 230, or a computing device having the integrated circuit memory device 230.

In FIG. 7, the memory device 230 has a secure memory region 233 storing a component 261 (e.g., a zeroth layer component) and component information 263. The component information 263 can include data about components (e.g., 265. 267) (e.g., a first layer component loaded by the zeroth layer component, a second layer component loaded by the first layer component) to be loaded for execution after the component 261.

The memory device 230 stores a unique device secret 201 that is unique to the memory device 230 among a population of similar memory devices.

During booting of a computing system having the memory device 230, a compound device identifier (CDI) of the component 261 is generated based on the unique device secret 201 and the TCB component identity (TCI) of the component 261; a compound device identifier (CDI) of the component 265 is generated, by the component 261, based on the compound device identifier (CDI) of the component 261 and the TCB component identity (TCI) of the component 265; and a compound device identifier (CDI) of the component 267 is generated, by the component 265, based on the compound device identifier (CDI) of the component 265 and the TCB component identity (TCI) of the component 267; etc.

The component information 263 can include at least the digest of the component 265 to be loaded by the component 261 and/or the digest of the component 267 to be loaded by the component 265. The component information 263 can further include the identification of storage locations of parts of the components (e.g., 265, 267, and/or the component 261). The storage locations can also be referred to as locations of measurement.

Thus, before the TCB component identity (TCI) of the component 265 is used to compute its compound device identifier (CDI) by the component 261, a security manager 213 of the memory device 230 (and/or a host system of the memory device 230 running the component 261) can compute the current digest of the component 265 as stored at the storage locations identified by the component information 263. The computed current digest can be compared to the digest in the component information 263 to determine the validity of the TCB component identity (TCI) of the component 265 and/or the integrity of the component 265. If the component 265 as stored is compromised or not healthy, the boot process can be suspended; and a repair and/or recovery operation can be performed. If the component 265 is healthy, its compound device identifier (CDI) can be computed by the component 261 from the TCB component identity (TCI) of the component 265 and the compound device identifier (CDI) of the component 261. Since the compound device identifier (CDI) of the component 261 is derived from the unique device secret 201, the possession of the compound device identifier (CDI) of the component 265 is evidence that the component 265 has access to the unique device secret 201.

Similarly, another component 267 (e.g., application) is to be loaded after and/or by the component 265 (e.g., operating system). A compound device identifier (CDI) of the component 267 is to be computed based on the compound device identifier (CDI) of the component 265, as a secret of the component 267, and the TCB component identity (TCI) of the component 267 to be loaded after the component 265. Since the compound device identifier (CDI) of the component 265 is indirectly derived from the unique device secret 201, the possession of the compound device identifier (CDI) of the component 267 is evidence that the component 265 has access to the unique device secret 201. The component information 263 can include the digest of the component 267 to be loaded after the component 265 and further include the identification of storage locations of parts of the component 267. Thus, before the TCB component identity (TCI) of the component 267 is used to compute a compound device identifier (CDI) of the component 267, the security manager 213 of the memory device 230 (and/or a host system of the memory device 230 running the component 261 and/or the component 265) can compute the current digest of the component 267 as stored at the storage locations (locations of measurement) identified by the component information 263. The computed current digest can be compared to the digest in the component information 263 to determine the validity of the TCB component identity (TCI) of the component 267 and/or the integrity of the component 267, in a way similar to the validation of the component 265.

In some implementations, there can be more layers of components than what is illustrated in FIG. 7. In other implementations, less layers of components than what is illustrated in FIG. 7 can be used in a computing device. Thus, the present disclosure is not limited to a particular number of layers of components that are linked or chained to generate their compound device identifiers.

FIG. 7 illustrates an example where the components 261, 265, . . . , 267 are stored in a non-secure memory region 231. Commands configured to access to the non-secure memory region 231 do not require signatures or verification codes generated using cryptographic keys representing the privileges to have the commands executed within the memory device 230. In other implementations, some or all of the components 261, 265, . . . , 267 can also be stored in the secure memory region 233 for enhanced security.

The integrated circuit memory device 230 can be enclosed in a single integrated circuit package. The integrated circuit memory device 230 includes multiple memory regions 231, . . . , 233 that can be formed in one or more integrated circuit dies.

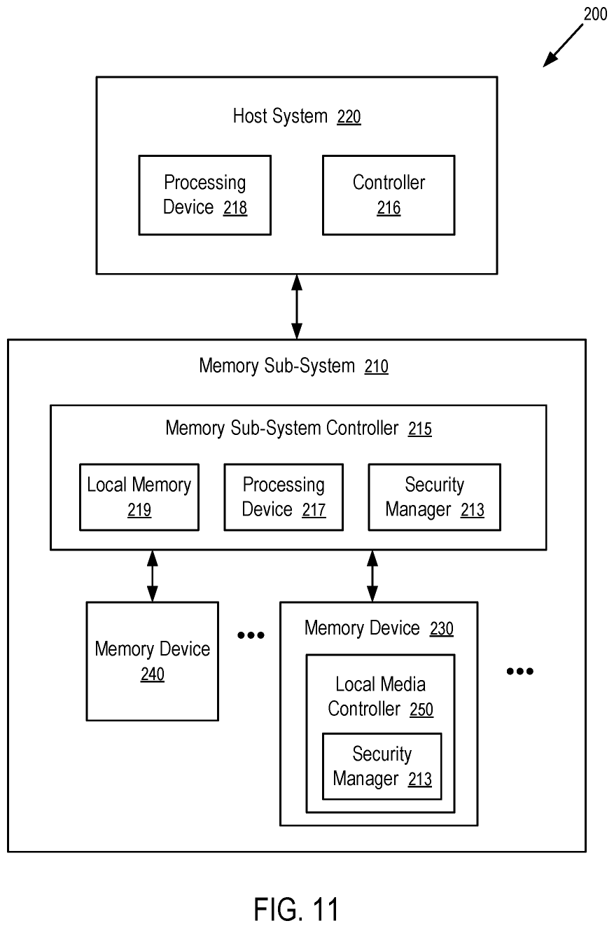

A memory region (e.g., 231 or 233) can be allocated for use by the host system as a partition or a namespace. Memory locations in the memory region (e.g., 231 or 233) can be specified by the host system via an address of logical block addressing (LBA); and the memory device 230 can include an address map that specifies the relation between LBA addresses in a partition or namespace and physical addresses of corresponding memory cells used to provide the storage space allocated to the partition or namespace. In some implementations, the memory device 230 is configured in a memory sub-system (e.g., 210 illustrated in FIG. 11); and a memory sub-system controller 215 can be configured to perform the address mapping for the memory device 230.

A typical memory cell in a memory region (e.g., 231, . . . , 233) can be programmed to store one or more bits of data.

The memory device 230 has a local media controller 250, which can implement at least a portion of a security manager 213.

The security manager 213 of the memory device 230 can include an access controller 209 and a cryptographic engine 207.

The cryptographic engine 207 can be implemented via a logic circuit and/or instructions or microcode to perform cryptographic calculations, such as applying a cryptographic hash function to a data item to generate a hash value, encrypting a data item to generate cipher text using a cryptographic key, decrypting cipher text to recover a data item using a corresponding cryptographic key, generating a cryptographic key of symmetric cryptography and/or a pair of cryptographic keys of asymmetric cryptography, etc.

The access controller 209 controls access to at least one of the memory regions 231, . . . , 233 and/or other functions of the memory device 230 based on cryptographic keys that are representative of access privileges.

For example, the security manager 213 can control access to a secure memory region 233 based on a cryptographic key that is generated based on a secret 201 of the integrated circuit memory device 230 and/or a cryptographic key representative of an owner or an authorized user of the memory device 230. For example, when a request or command to write data into the secure memory region 233 is received in the integrated circuit memory device 230, the security manager 213 verifies whether the request is from a requester having the cryptographic key. If no, the security manager 213 may reject the write request. To demonstrate that the request is from an authorized requester, the requester can digitally sign the request, or a challenge message, using the cryptographic key. When the security memory device 230 determines that the digital signature is made using the correct cryptographic key, the requester is seen to have the permission to write the data into the secure memory region 233. For example, the memory device 230 can store a cryptographic key that is used to authenticate the digital signature of the signed request/command.

The memory device 230 can be configured to use different cryptographic keys to access control different commands. For example, one cryptographic key can be representative of the privilege to have a security command executed in the memory device 230; and the security command is used to specify that another cryptographic key is representative of the privilege to read and/or write in a secure memory region 233. For example, the memory device 230 can have multiple secure memory regions (e.g., 233); and access to each of the secure memory regions (e.g., 233) can be controlled via a separate cryptographic key.

For example, the memory device 230 can have a unique device secret 201 that represents an identity of the memory device 230; and a cryptographic key derived from the unique device secret 201 can be representative of an owner privilege to operate the memory device 230 and thus have security commands executed in the memory device.

In general, the secure memory region 233 can have different security requirements for different types of accesses (e.g., read, write, erase). For example, the secure memory region 233 can be configured to require digital signatures verifiable via the cryptographic key to write or change data in the secure memory region 233 but does not require a signed command to read the data from the secure memory region 233. Alternatively, the secure memory region 233 can be configured to require digital signatures verifiable via the cryptographic key to read, write, and/or change data in the secure memory region 233. Alternatively, the secure memory region 233 can be configured to require digital signatures verifiable via different cryptographic keys for different operations, such as read, write, change, erase, etc., in the secure memory region 233.

The integrated circuit memory device 230 has a communication interface 247 to receive a command having an address 235. In response to the address 235 identifying a secure memory region (e.g., 233) that is configured with access control, the security manager 213 uses the cryptographic engine 207 to perform cryptographic operations for the verification that the request is from a requester having the cryptographic key authorized for the access to the memory region 233, before providing memory data retrieved from the memory region 233 using an address decoder 241. The address decoder 241 of the integrated circuit memory device 230 converts the address 235 into control signals to select a group of memory cells in the integrated circuit memory device 230; and the local media controller 250 of the integrated circuit memory device 230 performs operations to determine the memory data stored in the memory cells at the address 235.

FIG. 8 illustrates the generation of identity data in an integrated circuit memory device according to one embodiment. For example, the technique of FIG. 8 can be implemented in the memory device 230 of FIG. 7.

In FIG. 8, the cryptographic engine 207 of a memory device 230 (e.g., as in FIG. 7) is used to generate at least a secret key 237 using its unique device secret 201 and device information 221.

For example, when asymmetric cryptography is used, the secret key 237 is a private key of a cryptographic key pair 229. An associated public key 239 is generated together with the private key using the cryptographic engine 207.

Alternatively, when symmetric cryptography is used, the secret key 237 can be generated and used without a public key 239 and without the key pair 229.

In some implementations, multiple key pairs 229 are generated and used. For example, when a method of device identity composition engine (DICE) and robust internet-of-things (RIoT) is used, a first pair of asymmetric keys is referred to as device identification keys; and a second pair of asymmetric keys is referred to as alias keys. The private device identification key can be used to certify the authenticity of the alias keys and then immediately deleted and purged from the memory device 230 and to safeguard its secrecy, especially when the generation or use of the private device identification key occurs at least in part in the host system 220. The alias keys can be used in authentication in further transactions and/or communications. For example, the private device identification key can be generated at a boot time and used to sign certificates, such as a certificate of the alias public key, and then deleted. After the identity of the memory device 230 and the authenticity of the public alias key are validated or confirmed using the certificates signed using the private device identification key as the secret key 237, the private alias key can then be used as the secret key 237 of the memory device 230 in subsequent operations, until the host system 220 reboots.

For example, the data 223 stored in the memory cells 203 for the device information 221 can include a set of instructions (e.g., software, firmware, operating system, application) to be executed by the processing device 218 of the host system 220 to which the communication interface 247 of the memory device 230 is connected.

For example, the data 223 can include a cryptographic hash value of the set of instructions. For example, a known hash value of the set of instructions can be stored in the memory cells 203; and the current hash value of the set of instructions can be computed for comparison with the known hash value. If the two hash values agree with each other, the integrity of the set of instructions is verified; and the hash value of the integrity of the set of instructions can be used as part of the device information 221 to compute the secret key 237.

Alternatively, the current hash value of the set of instructions stored in the memory cells 203 can be used directly in the calculation of the secret key 237. If the instructions have changed (e.g., due to data corruption and/or tampering or hacking), the validation of the secret key 237 by a security server will fail.

Optionally, the data 223 can include an identification of the set of instructions, such as a hash value of the source code of the instructions, a name of the software/firmware package represented by the instructions, a version number and/or a release date of the package, etc.

Optionally, the data 223 can include trace data stored into the memory cells 203 during the process of building and/or customizing the computing system having the host system 220 and the memory device 230. For example, when the memory device 230 is assembled into a component device (e.g., a memory sub-system), a piece of trace data representative of the manufacturer of the component device, the model of the component device, and/or the serial number of the component device is stored into the memory cells 203 as part of the device information 221. Subsequently, when the component device is assembled into the computing system, a piece of trace data is added into the memory cells as part of the device information 221. Further trace data can be added to the memory cells 203 as part of the device information 221 to reflect the history of the memory device 230 for the individualization of the identity of the memory device 230.

Optionally, the device information 221 can further include data 225 received from the host system 220 to which the communication interface 247 of the memory device 230 is connected.

For example, the computing system can have at least the host system 220 and the memory device 230. Some of the components in the host system 220 may be removed or replaced. At the time of booting up the host system 220, a portion of the instructions stored the memory cell 203 is executed to collect data 225 about the components that are present in the host system 220 at the boot time. Thus, the device information 221 can represent a particular configuration of software/data and hardware combination of the memory device 230 and/or the host system 220. The secret key 237 generated based on the device information 221 and the unique device secret 201 represent the identity of the memory device 230 with the particular configuration.

To demonstrate the identity of the memory device 230 and/or the host system 220, the cryptographic engine 207 generates a verification code 253 from a message 243 and the secret key 237.

The verification code 253 of the secret key 237 and the message 243 can be constructed and/or validated using various techniques, such as hash digest, a digital signature, or a hash-based message authentication code, symmetric cryptography, and/or asymmetric cryptography. Thus, the verification code 253 is not limited to a particular implementation.

In general, verifying whether a sender of a message (e.g., 243) has a cryptographic key (e.g., 245) involves the validation of a verification code (e.g., 253) of the message (e.g., 243). The verification code can be in the form of a hash digest, a digital signature, a hash-based message authentication code (HMAC), a cipher-based message authentication code (CMAC), etc. The verification code is generated using the cryptographic key and the message as an input to cryptographic operations such as hashing, encrypting, and/or other computations such that it is generally impractical to generate the verification code without the cryptographic key and to generate the verification code from modified version of the message. Thus, when the recipient confirms that the received verification code is valid for the received message and a cryptographic key, the recipient can conclude that the sender has the corresponding cryptographic key and the received message is the same as the message used to generate the received cryptographic key.

In some implementations, the recipient performs the validation of a verification code of a message using the same cryptographic key as used by the sender to generate the verification code. For example, the recipient uses the same cryptographic key to generate the verification code of the received message and compare the generated verification code with the received verification code. If there is a match, the received verification code is valid for the received message; and the sender can be considered to have the cryptographic key. Otherwise, the received verification code is invalid for the received message; either the received message has been changed since the generation of the verification code, or the received verification code was generated using a different cryptographic key, or both.

In some implementations, the recipient performs the validation of a verification code of a message using a public cryptographic key in a key pair; and the sender generates the verification code using a private cryptographic key in the key pair. For example, the verification code can be generated by applying a hash function to the message to generate a hash value of the message. The cipher text of the hash value obtained through encrypting the hash value performed using an encryption key can be used as the verification code. A recipient of the message and the verification code performs validation using a corresponding decryption key, which is the same as the encryption key when symmetric cryptography is used and is a different key in a key pair when asymmetric cryptography is used. After recovering a hash value from the cipher text using the decryption key, the recovered hash value can be compared to the hash value of the received message; if there is a match, the received verification code is valid for the received message; otherwise, the received verification code is invalid for the received message. Alternatively, the recipient can use the encryption key to perform the validation without performing decryption. The recipient can generate the verification code of the message using the encryption key for comparison with the received verification code.

In some implementations, a message and a cryptographic key is combined to generate a hash value as the verification code, as in a technique of hash-based message authentication code (HMAC). For example, a cryptographic key can be used to generate two keys. After combining one of the two keys with the message to generate a message modified by the key, a cryptographic hash function can be applied to the key-modified message to generate a hash value, which is further combined with the other key to generate a further message. After applying the cryptographic hash function (or another cryptographic hash function) to the further message, a hash-based message authentication code is generated. A recipient of the message can use the same cryptographic key to generate the hash-based message authentication code of the received message for comparison with the received hash-based message authentication code. If there is a match, the validation is successful; otherwise, the validation fails.

In general, any techniques for generating and validating a verification code for a message from a sender and a cryptographic key used by the sender to generate the verification code can be used to determine whether the sender has the cryptographic key. The recipient is to use an appropriate cryptographic key to perform the validation, which can be the same as the cryptographic key used to generate the verification code, or in the same pair of asymmetric cryptographic key. Thus, the present disclosure is not limited to a particular technique of hash digest, digital signature, and/or hash-bashed message authentication code.

For convenience, a verification code (e.g., 253) generated for a message (e.g., 243) using a cryptographic key (e.g., 245) to represent both the message (e.g., 243) and the cryptographic key (e.g., 245) can be referred to, generally, as a digital signature of the message (e.g., 243) signed using the cryptographic key (e.g., 245), with the understanding that the verification code can be generated using various techniques, such as hash-based message authentication code.

Optionally, the message 243 can include a user identification, such as a name, an email address, a registered username, or another identifier of an owner or authorized user of the host system 220 in which the identity data 212 is generated.

Optionally, part of the message 243 can provide information in an encrypted form. For example, the information can be encrypted using a public key of the security server such that the information is not accessible to a third party.

The message 243 can be a certificate presenting the unique identification 211 of the memory device 230 and/or the host system 220. The message 243 can further present other data 227, such as a counter value maintained in the memory device 230, a cryptographic nonce, and/or other information related to the validation of the identity data 212. The memory device 230 can monotonically increase the counter value to invalidate identity data that have lower counter values to prevent replay attacks.

In some implementations, the data 227 can include part of the device information 221 used to generate the secret key 237.

In some implementations, the secret key 237 is a private alias key in a pair of asymmetric keys. The data 227 includes a certificate presenting the corresponding public alias key in the pair of asymmetric keys. The certificate presenting the public alias key is signed using a device identification key of the memory device 230. The public alias key can be used to validate the verification code 253 for the message 243 and the private alias key that is used as the secret key 237. Once the security server validates the certificate presenting the public alias key, signed using the device identification key of the memory device 230 and provided as part of the data 227, the security server can use the public alias key to validate the verification code 253 signed using the private alias key as the secret key 237. In such an implementation, the security server can use the public alias key provided in the message 243 to validate the verification code 253 without having to regenerate the pair of alias keys; and the memory device 230 can generate the alias key pair 229 using data not known to the security server.

The certificate presenting the public alias key can be generated and validated in a way as in FIG. 8, where the secret key 237 is the device identification key generated using the device information 221 and the unique device secret 201. Optionally, the memory device 230 initially provides the security server with the certificate having the public alias key. Subsequently, the memory device 230 can use the private alias key as the secret key 237 without including the public alias key in the message 243, or without including the certificate of the public alias key in the message 243.

Further, the verification of the identity of the memory device 230 can include the use of multiple secret keys and verification codes signed using the secret keys. For example, a device identification secret key can be used to initially establish the authenticity of an alias secret key and the identity of the memory device 230; and subsequently, the alias secret key can be used to validate the authenticity of the identity of the memory device 230. In general, the device identification secret key and the alias secret key can be based on asymmetric cryptography or symmetric cryptography, since the security server can generate the corresponding cryptographic keys generated by the memory device 230.

For improved security, the memory device 230 does not use the processing power outside of the memory device 230 to generate its copy of the secret key 237 and does not communicate the secret key 237 outside of the memory device 230. The generation and use of the secret key 237 are performed using the logic circuit of the cryptographic engine 207 sealed within the memory device 230.

Alternatively, part of operations to generate and use the secret key 237 can be implemented via a set of instructions stored in the memory cells 203 and loaded into the processing device 218 of the host system 220 for execution. For improved security, the secret key 237 is not communicated across the communication interface 247 in clear text; and the instructions can be configured to purge the secret key 237 from the host system 220 after the generation and/or after the use.

The identity data 212 can be generated in response to the memory device 230 being powered up, in response to a request received in the communication interface 247, and/or in response to the host system 220 boots up (e.g., by executing a boot-loader stored in the memory cells 203). The data 227 can include a count value maintained in the memory device 230. The count value increases when the operation to generate the identity data 212 is performed. Thus, a version of the identity data 212 having a count value invalidates prior versions of the identity data 212 having count values lower than the count value.

In some implementations, the data 223 includes multiple layers of components (e.g., component A 261, component B 265, component C 267); and the device information 221 include the component information 263 and the compound device identifiers of at least some of the components.

FIG. 9 illustrates a technique to control execution of a command in a memory device according to one embodiment. For example, the technique of FIG. 9 can be implemented in the memory device 230 of FIG. 7.

In FIG. 9, the access controller 209 is configured with an access control key 249 to determine whether a signed command 256 received in the communication interface 247 is from an entity having the privilege to have the command 255 executed in the secure memory device 230.

When a controller 216 of a host system 220 sends a command 255 to the communication interface 247 of the memory device 230, the access controller 209 determines whether the sender of the command 255 has the privilege to request the memory device 230 to execute the command 255. The host system 220 can include one or more processing devices 218 that execute instructions implementing an operating system and/or application programs.

A cryptographic key 245 is configured to represent the privilege that is to be checked using the access control key 249. A sender of the command 255 can generate a verification code 253 from the cryptographic key 245 and a message 243 containing the command 255.

Similar to the verification code 253 discussed above in connection with FIG. 8, the verification code 253 of the cryptographic key 245 and the message 243 can be constructed and/or validated using various techniques, such as hash digest, a digital signature, or a hash-based message authentication code, symmetric cryptography, and/or asymmetric cryptography. Thus, the verification code 253 is not limited to a particular implementation; and the verification code 253 can be referred to, generally, as a digital signature of the message 243 signed using the cryptographic key 245, with the understanding that the verification code 253 can be generated using various techniques, such as hash-based message authentication code.

In FIG. 9, the access controller 209 uses a corresponding access control key 249 to validate the verification code 253 submitted to the communication interface 247 for the command 255. The access controller 209 uses the cryptographic engine 207 to generate a validation result 259 of the received message 243 and the received verification code 253. Based on the validation result 259, the access controller 209 can selectively allow the command 255 to be executed within the memory device 230 or block the execution of the command 255.

For example, the access control key 249 can be one of the cryptographic keys stored in the memory device 230. Different access control keys can be used to control different privileges for executing different commands and/or for executing a command operating on different sections or regions of memory cells.

For example, one cryptographic key 245 can be representative of the privilege to have a security command executed in the memory device 230. When the security command is executed, an access control key 249 is installed (or uninstalled) in the memory device 230 for the validation of a verification code of another cryptographic key representative of the privilege to have a read command (or a write command) executed to access the secure memory region 233.

Optionally, the cryptographic key 245 is generated in the process of validating the identity of the memory device 230 based on the unique device secret 201 of the memory device 230; and a secret known between the memory device 230 and an owner of the memory device 230 allows the generation of a session key as the cryptographic key 245 to represent the privileges to have selected commands executed in the memory device 230 during a communication session. The communication session can have a time limit and/or be terminated via a command to the memory device 230.

In some implementations, a same session key used as the cryptographic key 245 representative of a privilege (e.g., to read or write the data in the secure memory region 233) and as the access control key 249 for the validation of verification codes (e.g., 253) generated using the cryptographic key 245.

In another implementations, a pair of cryptographic keys of asymmetric cryptography can be used for the session. The public key in the pair is used as the access control key 249; and the private key in the pair can be used as the cryptographic key 245 representative of the corresponding privilege.

After the installation in the memory device 230 the access control key 249 for the validation of the verification codes (e.g., 253) generated using the cryptographic key 245 representative of the privilege to read or write in the secure memory region 233, the cryptographic key 245 can be used by an authorized entity to generate the signed command 256. The signed command 256 can be transmitted to the communication interface 247 of the memory device 230 by the host system 220. After the access controller 209 validates the verification code 253 in the signed command 256, the access controller 209 allows the memory device 230 to execute the command 255.

The message 243 can include data 257 that represents restrictions on the request to execute the command 255.

For example, the data 257 can include an execution count value maintained within the memory device 230 such that verification codes generated for lower counts are invalidated.

For example, the data 257 can include a cryptographic nonce established for a specific instance of a request to execute the command 255 such that the verification code 253 cannot be reused for another instance.

For example, the data 257 can include a time window in which the verification code 253 is valid.

For example, the data 257 can include the identification of a memory region in which the command 255 is allowed to be executed.

For example, the data 257 can include a type of operations that is allowed for the execution of the command 255 in the memory device 230.

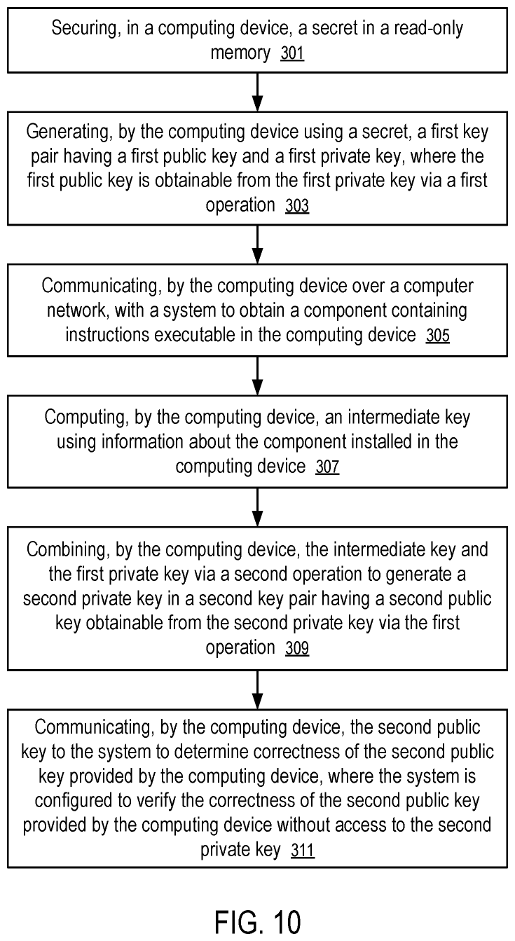

FIG. 10 shows a method to manage cryptographic keys according to one embodiment.

For example, the method of FIG. 10 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the method of FIG. 10 can be implemented in a system of FIG. 5 or FIG. 6 and performed at least in part by a processing device (e.g., a processor 173 or a controller 250) in a device (e.g., 171, 181, or 183) or a server (e.g., 179). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 301, the method includes securing, in a computing device (e.g., 171, 181, 230, or 200), a secret (e.g., 151, or 201) in a read-only memory (e.g., 175).

For example, the secret (e.g., 131, 151, or 201) can be configured in an integrated circuit memory device (e.g., 230) during the manufacturing of the memory device (e.g., 230) and is not communicated to outside of the memory device (e.g., 230) after the completion of the manufacture of the memory device (e.g., 230).

For example, the secret (e.g., 131, 151, or 201) can be configured to be unique to the memory device (e.g., 230) among a population of memory devices. The secret (e.g., 131, 151, or 201) can be the basis of the identity of the memory device (e.g., 230), the identity of the computing device (e.g., 171, 181, or 200) in which the memory device (e.g., 230) is installed, and the identity of a software/firmware/application component (e.g., 161) running in the computing device (e.g., 171, 181, or 200).

For example, a processor (e.g., 173, 250, 217, or 218) can be configured to compute a key pair (e.g., 105) based at least in part on the secret (e.g., 131, 151, or 201) to represent the identity of the memory device (e.g., 230), the computing device (e.g., 171, 181, or 200) having the memory device (e.g., 230), or the component (e.g., 161) running in the computing device (e.g., 171, 181, or 200).

In some implementations, the secret (e.g., 131, 151, or 201) can be a private key (e.g., 109) of an asymmetric cryptographic key pair (e.g., 105) or a compound device identifier (e.g., 106).

At block 303, the method includes generating, by the computing device (e.g., 171, 181, 230, or 200) using the secret (e.g., 131, 151, or 201), a first key pair (e.g., 105) having a first public key (e.g., 107) and a first private key (e.g., 109). The first public key (e.g., 107) is obtainable from the first private key (e.g., 109) via a first operation (e.g., as in elliptic curve cryptography).

For example, the first operation can include the multiplication of the first private key (e.g., 109) by a predetermined number (e.g., a generator element of a group used for public key operations).

At block 305, the method includes communicating, by the computing device (e.g., 171, 181, 230, or 200) over a computer network (e.g., 420), with a system (e.g., server 179 or device 183) to obtain a component (e.g., 163) containing instructions executable in the computing device (e.g., 171, 181, 230, or 200).

For example, the computing device (e.g., 171, 181, 230, or 200) can download the component (e.g., 163) from the server 179 for installation, or for an over the air update.

For example, the system (e.g., server 179 or device 183) can include a memory configured to store the component (e.g., 163) for distribution and the first public key (e.g., 107) of the computing device (e.g., 171, 181, 230, or 200). Further, the system (e.g., server 179 or device 183) can include a communication device to communicate with the computing device (e.g., 171, 181, 230, or 200) over the network 420 and a processor configured to check the correctness of the installation of the component (e.g., 163) in the computing device (e.g., 171, 181, 230, or 200) via the determination of the correctness of an alias key certificate 124 of the component (e.g., 163) in the computing device (e.g., 171, 181, 230, or 200).

At block 307, the method includes computing, by the computing device (e.g., 171, 181, 230, or 200), an intermediate key (e.g., an intermediate private key 119) using information (e.g., measurement 143, context 145) about the component (e.g., 163) installed in the computing device (e.g., 171, 181, 230, or 200).

For example, the information about the component 163 installed in the computing device (e.g., 171, 181, 230, or 200) can include a cryptographic measurement of the component 163.

For example, the information about the component 163 installed in the computing device (e.g., 171, 181, 230, or 200) can include context information unique to the computing device (e.g., 171, 181, 230, or 200).

For example, the information about the component 163 installed in the computing device (e.g., 171, 181, 230, or 200) can include a secret derived from a key exchange over the computer network, as in FIG. 6. For example, the key exchange can be in accordance with a protocol of peer-to-peer Diffie-Hellman (DH) key exchange during the communications to retrieve the component 163 from the server 179.

At block 309, the method includes combining, by the computing device (e.g., 171, 181, 230, or 200), the intermediate key (e.g., an intermediate private key 119) and the first private key (e.g., 109) via a second operation (e.g., summation or multiplication) to generate a second private key (e.g., 129) in a second key pair (e.g., 125) having a second public key (e.g., 127) that is obtainable from the second private key (e.g., 129) via the first operation.

In some applications, the second private key (e.g., 129) is generated outside of the context of installing a component (e.g., 163). For example, the second private key (e.g., 129) can be generated to replace the first private key (e.g., 109), or to reduce the usage of the first private key (e.g., 109), or to communicate in a session. In such applications, the operations in block 305 can be skipped; and the intermediate key can be generated from other information shared between the system (e.g., device 183) and the computing device (e.g., device 181). Such information can include context information (e.g., context 145) relates to the generation of the second private key (e.g., 129), such as a secret established via a key exchange for a communication session.

For example, instead of communicating to obtain a component (e.g., 163) in block 305, the computing device (e.g., 171, 181, 230, or 200) and the system (e.g., device 183 or server 179) can communicate 185 to establish a shared secret (e.g., via Diffie-Hellman (DH) key exchange) and to establish inputs known to both the computing device (e.g., 171, 181, 230, or 200) and the system (e.g., device 183 or server 179). The inputs can include the shared secret and used to generate the intermediate private key 119.

At block 311, the method includes communicating, by the computing device (e.g., 171, 181, 230, or 200), the second public key (e.g., 127) to the system (e.g., server 179 or device 183) to determine correctness of the second public key (e.g., 127) provided by the computing device. The system (e.g., server 179 or device 183) is configured to verify the correctness of the second public key (e.g., 127) provided by the computing device (e.g., 171, 181, 230, or 200) without access to the second private key (e.g., 129).

For example, as in FIG. 2 and FIG. 3, the second private key 129 can be generated from the second operation of a sum 139 or a multiplication 149 between the intermediate private key 119 and the first private key (e.g., 109). As a resulting, the external system (e.g., server 179 or device 183) can separately compute a version of the second public key 127 using the public key 107 and the intermediate private key 119 to verify the correctness of the second public key 127 provided by the computing device (e.g., 171, 181, 230, or 200). The verification or validation of the second public key 127 by the external server 179 does not require any data that can reveal the second private key 129, the first private key 109, and/or the secret (e.g., 131, 151, or 201) of the computing device (e.g., 171, 181, 230, or 200).

In some applications, the component 163 is a second component 163 configured to run on top of a first component 161 installed in the computing device (e.g., 171, 181, 230, or 200); and the first key pair 105 can be configured as a compound device identifier 106 of the first component 161 running in the computing device (e.g., 171, 181, 230, or 200); and the second key pair 125 can be configured as an alias key pair 125 provided to the second component 163 running in the computing device as a secret of the second component 163.

For example, the method can further include re-installing the second component 163 from the system (e.g., server 179) over the computer network 420 in response to a determination that the second public key 127 provided by the computing device (e.g., 171, 181, 230, or 200) is incorrect.

For example, the second public key 127 can be provided to the system (e.g., server 179) in an alias key certificate 124. For example, the server 179 can reject (or cause rejections of) services to the second component 163 running in the computing device (e.g., 171, 181, 230, or 200) when the alias key certificate 124 is determined by the server 179 to be incorrect.

FIG. 11 illustrates an example computing system 200 that includes a memory sub-system 210 in accordance with some embodiments of the present disclosure. For example, the device 171 or the server 179 of FIG. 5, or the device 181 or 183 in FIG. 6, can be implemented via a computing system 200 of FIG. 11. The memory sub-system 210 can be configured based on an integrated circuit memory device 230 of FIG. 7.

The memory sub-system 210 can include media, such as one or more volatile memory devices (e.g., memory device 240), one or more non-volatile memory devices (e.g., memory device 230), or a combination of such.

A memory sub-system 210 can be a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 200 can be a computing device such as a desktop computer, a laptop computer, a network server, a mobile device, a vehicle (e.g., airplane, drone, train, automobile, or other conveyance), an internet of things (loT) enabled device, an embedded computer (e.g., one included in a vehicle, industrial equipment, or a networked commercial device), or such a computing device that includes memory and a processing device.

The computing system 200 can include a host system 220 that is coupled to one or more memory sub-systems 210. FIG. 11 illustrates one example of a host system 220 coupled to one memory sub-system 210. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 220 can include a processor chipset (e.g., processing device 218) and a software stack executed by the processor chipset. The processor chipset can include one or more cores, one or more caches, a memory controller (e.g., controller 216) (e.g., NVDIMM controller), and a storage protocol controller (e.g., PCIe controller, SATA controller). The host system 220 uses the memory sub-system 210, for example, to write data to the memory sub-system 210 and read data from the memory sub-system 210.

The host system 220 can be coupled to the memory sub-system 210 via a physical host interface. Examples of a physical host interface include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, or any other interface. The physical host interface can be used to transmit data between the host system 220 and the memory sub-system 210. The host system 220 can further utilize an NVM express (NVMe) interface to access components (e.g., memory devices 230) when the memory sub-system 210 is coupled with the host system 220 by the PCIe interface. The physical host interface can provide an interface for passing control, address, data, and other signals between the memory sub-system 210 and the host system 220. FIG. 11 illustrates a memory sub-system 210 as an example. In general, the host system 220 can access multiple memory sub-systems via a same communication connection, multiple separate communication connections, and/or a combination of communication connections.

The processing device 218 of the host system 220 can be, for example, a microprocessor, a central processing unit (CPU), a processing core of a processor, an execution unit, etc. In some instances, the controller 216 can be referred to as a memory controller, a memory management unit, and/or an initiator. In one example, the controller 216 controls the communications over a bus coupled between the host system 220 and the memory sub-system 210. In general, the controller 216 can send commands or requests to the memory sub-system 210 for desired access to memory devices 230, 240. The controller 216 can further include interface circuitry to communicate with the memory sub-system 210. The interface circuitry can convert responses received from the memory sub-system 210 into information for the host system 220.

The controller 216 of the host system 220 can communicate with the controller 215 of the memory sub-system 210 to perform operations such as reading data, writing data, or erasing data at the memory devices 230, 240 and other such operations. In some instances, the controller 216 is integrated within the same package of the processing device 218. In other instances, the controller 216 is separate from the package of the processing device 218. The controller 216 and/or the processing device 218 can include hardware such as one or more integrated circuits (ICs) and/or discrete components, a buffer memory, a cache memory, or a combination thereof. The controller 216 and/or the processing device 218 can be a microcontroller, special purpose logic circuitry (e.g., a field programmable gate array (FPGA), an application specific integrated circuit (ASIC), etc.), or another suitable processor.

The memory devices 230, 240 can include any combination of the different types of non-volatile memory components and/or volatile memory components. The volatile memory devices (e.g., memory device 240) can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 230 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 230 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells of the memory devices 230 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 230 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative- or (NOR) flash memory, and electrically erasable programmable read-only memory (EEPROM).

A memory sub-system controller 215 (or controller 215 for simplicity) can communicate with the memory devices 230 to perform operations such as reading data, writing data, or erasing data at the memory devices 230 and other such operations (e.g., in response to commands scheduled on a command bus by controller 216). The controller 215 can include hardware such as one or more integrated circuits (ICs) and/or discrete components, a buffer memory, or a combination thereof. The hardware can include digital circuitry with dedicated (e.g., hard-coded) logic to perform the operations described herein. The controller 215 can be a microcontroller, special purpose logic circuitry (e.g., a field programmable gate array (FPGA), an application specific integrated circuit (ASIC), etc.), or another suitable processor.

The controller 215 can include a processing device 217 (e.g., processor) configured to execute instructions stored in a local memory 219. In the illustrated example, the local memory 219 of the controller 215 includes an embedded memory configured to store instructions for performing various processes, operations, logic flows, and routines that control operation of the memory sub-system 210, including handling communications between the memory sub-system 210 and the host system 220.

In some embodiments, the local memory 219 can include memory registers storing memory pointers, fetched data, etc. The local memory 219 can also include read-only memory (ROM) for storing micro-code. While the example memory sub-system 210 in FIG. 11 has been illustrated as including the controller 215, in another embodiment of the present disclosure, a memory sub-system 210 does not include a controller 215, and can instead rely upon external control (e.g., provided by an external host, or by a processor or controller separate from the memory sub-system).

In general, the controller 215 can receive commands or operations from the host system 220 and can convert the commands or operations into instructions or appropriate commands to achieve the desired access to the memory devices 230. The controller 215 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 230. The controller 215 can further include host interface circuitry to communicate with the host system 220 via the physical host interface. The host interface circuitry can convert the commands received from the host system into command instructions to access the memory devices 230 as well as convert responses associated with the memory devices 230 into information for the host system 220.

The memory sub-system 210 can also include additional circuitry or components that are not illustrated. In some embodiments, the memory sub-system 210 can include a cache or buffer (e.g., DRAM) and address circuitry (e.g., a row decoder and a column decoder) that can receive an address from the controller 215 and decode the address to access the memory devices 230.

In some embodiments, the memory devices 230 include local media controllers 250 that operate in conjunction with the memory sub-system controller 215 to execute operations on one or more memory cells of the memory devices 230. An external controller (e.g., memory sub-system controller 215) can externally manage the memory device 230 (e.g., perform media management operations on the memory device 230). In some embodiments, a memory device 230 is a managed memory device, which is a raw memory device combined with a local controller (e.g., local media controller 250) for media management within the same memory device package. An example of a managed memory device is a managed NAND (MNAND) device.

The controller 215 and/or a memory device 230 can include a security manager 213 discussed above. In some embodiments, the controller 215 and/or the local media controller 250 in the memory sub-system 210 can include at least a portion of the security manager 213. In other embodiments, or in combination, the controller 216 and/or the processing device 218 in the host system 220 can include at least a portion of the security manager 213. For example, the controller 215, the controller 216, and/or the processing device 218 can include logic circuitry implementing the security manager 213. For example, the controller 215, or the processing device 218 (e.g., processor) of the host system 220, can be configured to execute instructions stored in memory for performing the operations of the security manager 213 described herein. In some embodiments, the security manager 213 is implemented in an integrated circuit chip disposed in the memory sub-system 210. In other embodiments, the security manager 213 can be part of firmware of the memory sub-system 210, an operating system of the host system 220, a device driver, or an application, or any combination therein.

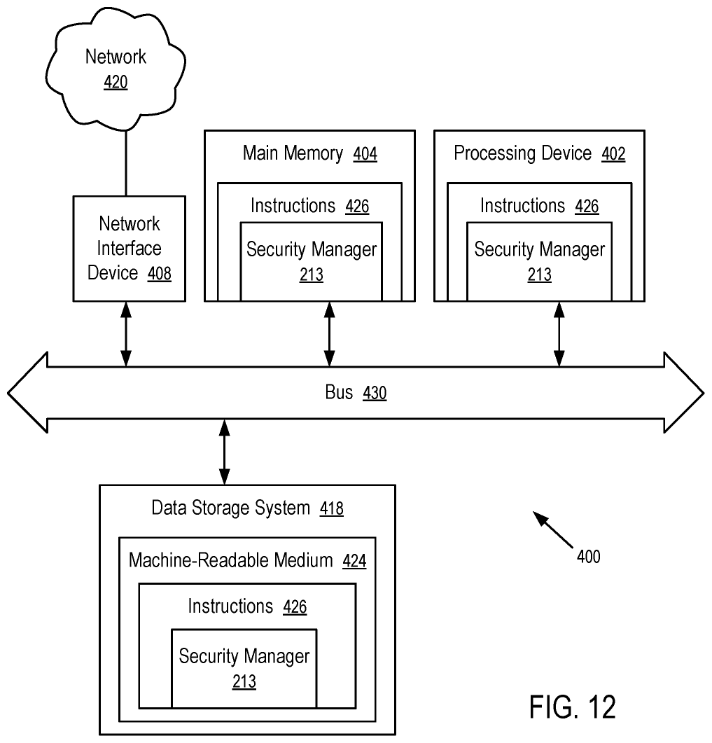

FIG. 12 illustrates an example machine of a computer system 400 within which a set of instructions, for causing the machine to perform any one or more of the methodologies discussed herein, can be executed. In some embodiments, the computer system 400 can correspond to a host system (e.g., the host system 220 of FIG. 11) that includes, is coupled to, or utilizes a memory sub-system (e.g., the memory sub-system 210 of FIG. 11) or can be used to perform the operations of a security manager 213 (e.g., to execute instructions to perform operations corresponding to the security manager 213 described with reference to FIGS. 1-8). In alternative embodiments, the machine can be connected (e.g., networked) to other machines in a LAN, an intranet, an extranet, and/or the internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), static random access memory (SRAM), etc.), and a data storage system 418, which communicate with each other via a bus 430 (which can include multiple buses).

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable medium 424, data storage system 418, and/or main memory 404 can correspond to the memory sub-system 210 of FIG. 11.

In one embodiment, the instructions 426 include instructions to implement functionality corresponding to a security manager 213 (e.g., the security manager 213 described with reference to FIGS. 1-8). While the machine-readable medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
securing, in a computing device, a secret in a read-only memory;
generating, by the computing device using the secret, a first key pair having a first public key and a first private key, wherein the first public key is obtainable from the first private key via a first operation;
communicating, by the computing device over a computer network, with a system to obtain a component containing instructions executable in the computing device;
computing, by the computing device, an intermediate key using information about the component installed in the computing device;
combining, by the computing device, the intermediate key and the first private key via a second operation to generate a second private key in a second key pair having a second public key obtainable from the second private key via the first operation; and
communicating, by the computing device, the second public key to the system to determine correctness of the second public key provided by the computing device, wherein the system is configured to verify the correctness of the second public key provided by the computing device without access to the second private key.

2. The method of claim 1, wherein the first operation includes multiplication by a predetermined number.

3. The method of claim 2, wherein the second operation includes summing the intermediate key and the first private key; and the system is configured to verify the correctness of the second public key via computing a version of the second public key from summing the first public key and an intermediate public key computed from the intermediate key using the first operation.

4. The method of claim 2, wherein the second operation includes multiplying the intermediate key by the first private key; and the system is configured to verify the correctness of the second public key via computing a version of the second public key from multiplying the first public key and the intermediate key.

5. The method of claim 2, wherein the information about the component installed in the computing device includes a cryptographic measurement of the component.

6. The method of claim 5, wherein the information about the component installed in the computing device further includes context information unique to the computing device.

7. The method of claim 6, wherein the information about the component installed in the computing device further includes a secret derived from a key exchange over the computer network.

8. The method of claim 7, wherein the key exchange is according to a protocol of peer-to-peer Diffie-Hellman (DH) key exchange.

9. The method of claim 6, wherein the component is a second component configured to run on top of a first component installed in the computing device; and the first key pair is configured as a compound device identifier of the first component running in the computing device; and the second key pair is configured as an alias key pair provided to the second component running in the computing device as a secret.

10. The method of claim 9, further comprising:
re-installing the second component from the system over the computer network in response to a determination that the second public key provided by the computing device is incorrect.

11. A computing device, comprising:
a communication device; and
a processor configured to:
generate an intermediate key from inputs;
combine the intermediate key with a first private key to generate a second private key;
compute a second public key of the second private key; and
communicate, using the communication device, the second public key to a remote device for validation without the remote device having access to the second private key.

12. The computing device of claim 11, further comprising:
a memory device configured with a secret unique to the memory device among a population of memory devices, wherein the processor is further configured to compute the first private key from the secret.

13. The computing device of claim 12, wherein the processor is further configured to communicate with the remote device over a computer network to establish the inputs known to both the computing device and the remote device.

14. The computing device of claim 13, wherein the inputs include a secret established via a protocol of Diffie-Hellman (DH) key exchange.

15. The computing device of claim 14, wherein the second public key is computable from the second private key via multiplication by a predetermined number; and a first public key is computable from the first private key via multiplication by the predetermined number.

16. The computing device of claim 15, wherein the second private key is generated from a summation of the intermediate key with the first private key or a multiplication of the first private key by the intermediate key; and the second public key is computable from first public key and the intermediate key without the first private key and without the second private key.

17. A server system, comprising:
a memory configured to store a component and a first public key of a computing device;
a communication device; and
a processor configured to:
communicate, using the communication device, the component to the computing device to cause installation of the component in the computing device, wherein the computing device is configured to compute a second key pair, including a second private key and a second public key, from a first private key associated with the first public key in a first key pair;
receive, from the computing device, the second public key; and
determine correctness of the second public key without data to identify the first private key and without data to identify the second private key.

18. The server system of claim 17, wherein the second key pair is computed in the computing device using inputs known to both the server system and the computing device.

19. The server system of claim 18, wherein the inputs include a secret established according to a protocol of Diffie-Hellman (DH) key exchange during communications of the component to the computing device; and the inputs further include a cryptographic measurement of the component installed in the computing device.

20. The server system of claim 19, wherein the second private key is generated from a summation of the intermediate key with the first private key or a multiplication of the first private key by the intermediate key; and the processor is further configured to compute the intermediate key from the inputs and compute a version of the second public key from a summation of the first public key and a public key of the intermediate key, or a multiplication of the first public key by the intermediate key.
